(19) United States
(12) Patent Application Publication
(10) Pub. No.: US 2015/0145242 A1
(43) Pub. Date: May 28, 2015

(54) ALTERNATIVES TO WELDING RETENTION SLEEVES ON STEEL TUBES

(71) Applicant: Oceaneering International, Inc., Houston, TX (US)

(72) Inventors: Stephen Owen Mast, Cypress, TX (US); Alan Hendry Gibson, Edinburgh (GB); Ross Doak, Edinburgh (GB)

(73) Assignee: OCEANEERING INTERNATIONAL, INC., Houston, TX (US)

(21) Appl. No.: 14/553,794

(22) Filed: Nov. 25, 2014

Related U.S. Application Data
(60) Provisional application No. 61/908,586, filed on Nov. 25, 2013.

(51) Int. Cl. F16L 13/10; B32B 38/00; B32B 37/22; B32B 37/12

(52) U.S. Cl. CPC F16L 13/103; B32B 37/12; B32B 38/0012; B32B 37/22; B32B 2597/00
USPC 285/294.1; 156/330; 156/60; 156/196

(57) ABSTRACT

A retention sleeve comprising a predetermined material and shape which provides a predetermined tensile capability may be placed about a tube to be disposed in an umbilical without the use of a welded retention sleeve by selecting a high strength glue or epoxy and using that high strength glue or epoxy to affix the retention sleeve at a predetermined position along a length of a tube disposed in an umbilical.

### RELATION TO OTHER APPLICATIONS

This application claims priority U.S. Provisional Patent Application 61/908,586 filed Nov. 25, 2013.

### BACKGROUND OF THE INVENTION

It has been shown in tensile and torsion tests that the current termination design without intervention such as the addition of a welded collar or other retention device did not provide retention strength above the summed specified minimum yield force of the potted steel tubes. This therefore breaches section 4.1.2 of ISO 13628-5:2009 which states that a termination should not downgrade the system performance below the functional requirements.

In an effort to increase the force required to pull one or more steel tubes and other components through an umbilical termination, a metallic sleeve is sometimes welded to the outside of a super duplex tube in an umbilical. This sleeve increases the surface area for which a potting compound can grip and also provides a ledge to ensure the steel tube is held more securely. This welding can be time consuming and, because it is done in the tight confines of an umbilical termination, can lead to additional work and additional tube bending in order to fit all of the sleeves. For example, when one or more retention sleeves are used in an umbilical, preparation, welding, and inspecting sleeves for each tube in an umbilical currently takes a lot of technician time, even extending to hours. Welding also introduces additional risk as it can introduce heat, and thus sigma phase, into the steel tubes.

Additionally, fillet welds associated with current retention sleeve technology cannot be inspected via x-ray. Because of this inspection requirement, some customers have prohibited non-inspected welds on tubes. This has led to the introduction of welding a spool piece into the tubes which now will require two additional butt welds.

In addition, in order to provide the additional space to weld sleeves, terminations have to be larger and heavier, and tubes bent more, which can cause additional damage to the tubes.

End terminations facilitate a means of connecting umbilicals to relevant destination hardware. Current art end terminations can be seen to have a number of key design features including requiring an internal cavity taper angle range between 3-12°. Moreover, some current designs result in the main resin cavity being relatively crowded with steel tubes—the main load bearing element—and electrical cables.

### DESCRIPTION OF THE DRAWINGS

Various figures are included herein which illustrate aspects of embodiments of the disclosed inventions.

FIG. 1 is a cutaway view in partial perspective of an umbilical;

FIG. 2 is a block schematic view of an umbilical illustrating tube bends; and

FIG. 3 is a view in partial perspective of a retention sleeve.

### BRIEF DESCRIPTION OF EMBODIMENTS OF THE INVENTION

As used herein the following terms have the following meanings: ID—inner diameter; OD—Outer Diameter; and Retention Strength—the maximum tensile capacity of a termination joint prior to a tube moving relative to a resin.

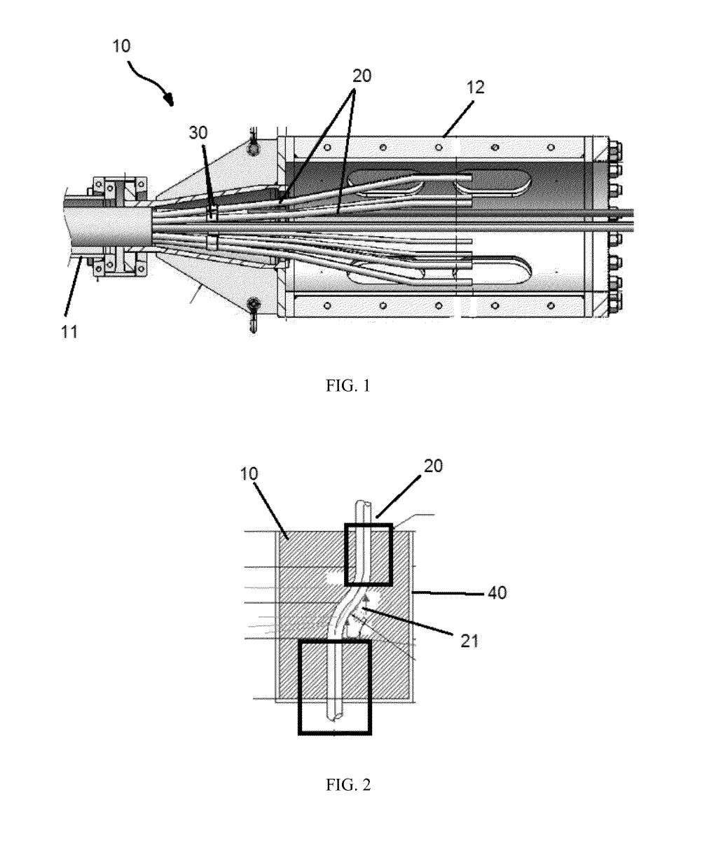

Referring now to FIG. 1, umbilical 10 comprises an umbilical housing 10, comprising extension component 11 and casing main housing 12; one or more tubes 20 disposed within umbilical tube 10; and one or more retention sleeves 30, each retention sleeve 30 affixed to a corresponding tube 20 using a high strength glue comprising sufficient strength to provide additional pullout force on tube 20 with very little manual labor, decreasing the size of the terminations, reducing the amount of tube bending required such as at bend 21 (FIG. 2), and reducing the welding and inspection labor required for each sleeve weld.

As will be understood by those of ordinary skill in the umbilical arts, umbilical 10 may comprise a plurality of tubes 20, each or a subset of which comprises a corresponding retention sleeve 30.

In any embodiment and method, tube 20 may comprise a steel tube which may be a load bearing steel tube such as a tensioned load bearing steel tube.

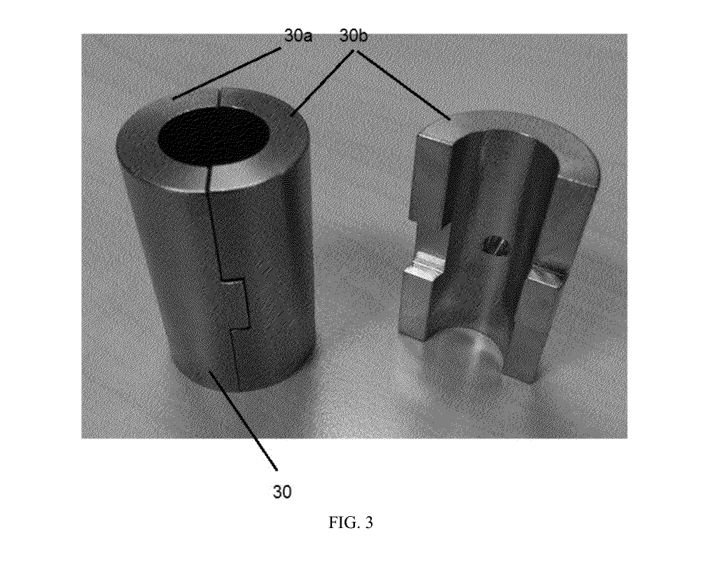

Retention sleeve 30 may be a single piece or comprise a plurality of sleeve pieces, e.g. retention sleeve 30a and retention sleeve 30b (FIG. 3). Retention sleeve 30 typically comprises a metal. In most embodiments, retention sleeve 30 comprises a load bearing surface comprising an area large enough so that when an ultimate tensile force of tube 20 is reached the stress on a surrounding potting resin is below the resin's compressive limit. Retention sleeve 30 also typically comprises a length designed such that there is sufficient area to disperse the lap shear stress on glue, e.g. an epoxy, imparted from a tube 20 such that the lap shear strength is not exceeded.

Further, in any embodiment and method, the length of the retention sleeve 30 may be configured to comprise an area sufficient to disperse a lap shear stress on the glue imparted from tube 20, e.g. a load bearing steel tube, such that the lap shear strength is not exceeded.

In the operation of preferred embodiments, tube 20 may be terminated or otherwise reinforced within umbilical 10 without the use of a welded retention sleeve 30 by selecting and using a high strength epoxy, where the high strength epoxy comprises a predetermined strength sufficient to provide additional pullout force on a tube such as a steel tube with very little manual labor. Typically, the predetermined strength comprises a strength sufficient so that a lap shear strength of the epoxy is not exceed when tube 20, such as a load bearing steel tube, is pulled at its yield stress.

Retention sleeve 30 is selected to comprise predetermined material and shape which can provide a predetermined tensile capability at a predetermined position along a length of tube 20, generally an increased tensile capability. Generally, such a position is within transition flange 13 (FIG. 1) which is disposed intermediate extension component 11 and casing main housing 12 at a topside termination point where the tensile strength loading on tube 20 is the highest.

Retention sleeve 30 is positioned at the predetermined position along the length of steel tube 20. If retention sleeve 30 comprises a plurality of parts, such positioning can occur prior to or when tube 20 is at least partially disposed within umbilical 10, such as within transition flange 13 (FIG. 1). In embodiments where retention sleeve 30 comprises a single part, retention sleeve 30 can be slid or otherwise guided over steel tube 20, either before or after inserting tube 20 into umbilical 10.

Once positioned, retention sleeve 30 is affixed to steel tube 20 at the predetermined position along the length of tube 20 using a high strength epoxy. The epoxy typically comprises a single part epoxy or two-part epoxy.

In a further embodiment, tube 20 is terminated or otherwise reinforced in umbilical 10 without the use of a welded retention sleeve by affixing retention sleeve 30, comprising a predetermined length, to tube 20, which may be metal and/or comprise steel, using a high strength glue, the high strength glue comprising a strength sufficient to provide additional pullout force on tube 20 disposed within umbilical 10 with very little manual labor and of sufficient strength so that a lap shear strength of the high strength glue is not exceeded when tube 20 is pulled to yield.

As with other embodiments, retention sleeve 30 is selected to comprise a predetermined material and shape to provide additional tensile capability to an umbilical termination of tube 20 when tube 20 is disposed within umbilical 10.

Retention sleeve 30, which typically comprises a suitable metal, is positioned at the predetermined position along the length of tube 20. As above, if retention sleeve 30 comprises a plurality of parts, such positioning can occur prior to or when tube 20 is at least partially disposed within umbilical 10. In embodiments where retention sleeve 30 comprises a single part, retention sleeve 30 can be slid or otherwise guided over steel tube 20.

Once positioned, retention sleeve 30 is affixed to tube 20 at the predetermined position along the length of tube 20 using the high strength glue proximate a termination end of tube 20. The glue may comprise a resin, a single-part epoxy, a two-part epoxy, or the like, or a combination thereof.

If the glue comprises a resin, retention sleeve 30 may be designed such that its load bearing surface comprises an area configured such that when the yield of tube 20 is reached the stress on a surrounding potting resin is below the resin's compressive limit.

The foregoing disclosure and description of the inventions are illustrative and explanatory. Various changes in the size, shape, and materials, as well as in the details of the illustrative construction and/or an illustrative method may be made without departing from the spirit of the invention.

We claim:

1. A method of placing a retention sleeve about a tube to be disposed in an umbilical without the use of a welded retention sleeve, comprising:
a. selecting a high strength epoxy, the high strength epoxy comprising a predetermined strength sufficient to provide additional pullout force on a tube with very little manual labor, the predetermined strength comprising a strength sufficient so that a lap shear strength of the high strength epoxy is not exceed when a load bearing tube is pulled at its yield stress;
b. disposing the tube within an umbilical;
c. selecting a retention sleeve of predetermined material and shape to provide a predetermined tensile capability at a predetermined position along a length of the tube;
d. positioning the retention sleeve at the predetermined position along the length of the tube; and
e. affixing the retention sleeve to the tube at the predetermined position along the length of the tube using the high strength epoxy.

2. The method of terminating a tube in an umbilical without the use of a welded retention sleeve of claim 1, wherein the epoxy comprises a single part epoxy.

3. The method of terminating a tube in an umbilical without the use of a welded retention sleeve of claim 1, wherein the epoxy comprises a two-part epoxy.

4. The method of terminating a tube in an umbilical without the use of a welded retention sleeve of claim 1, wherein the retention sleeve comprises a metal.

5. The method of terminating a tube in an umbilical without the use of a welded retention sleeve of claim 4, wherein the metal comprises steel.

6. The method of terminating a tube in an umbilical without the use of a welded retention sleeve of claim 1, wherein the retention sleeve comprises a load bearing surface comprising an area large enough so that when an ultimate tensile force of the tube is reached the stress on a surrounding potting resin is below the high strength epoxy's compressive limit.

7. The method of terminating a tube in an umbilical without the use of a welded retention sleeve of claim 1, wherein the retention sleeve comprises a length designed such that there is sufficient area to disperse lap shear stress on the high strength epoxy imparted from a tensioned tube such that the lap shear strength is not exceeded.

8. The method of terminating a tube in an umbilical without the use of a welded retention sleeve of claim 1, wherein:
a. the predetermined tensile capability comprises increasing the tensile capability; and
b. the predetermined position along a length of the tube comprises a position at a topside termination.

9. A method of terminating a steel tube in an umbilical without the use of a welded retention sleeve, comprising:
a. selecting a retention sleeve of predetermined material, predetermined length, and predetermined shape to provide additional tensile capability to an umbilical termination of a steel tube disposed within the umbilical tube; and
b. affixing the retention sleeve to a steel tube using a high strength glue, the high strength glue comprising a strength sufficient to provide additional pullout force on the steel tube once the steel tube is disposed within an umbilical with very little manual labor and comprising sufficient strength so that a lap shear strength of the high strength glue is not exceeded when the steel tube is pulled to yield;

10. The method of terminating a steel tube in an umbilical without the use of a welded retention sleeve of claim 9, further comprising:
a. decreasing a size of an umbilical termination end of the steel tube; and
b. gluing the retention sleeve proximate a termination end of the steel tube using the high strength glue.

11. The method of terminating a steel tube in an umbilical without the use of a welded retention sleeve of claim 9, wherein the retention sleeve comprises a metal.

12. The method of terminating a steel tube in an umbilical without the use of a welded retention sleeve of claim 9, wherein the glue comprises a resin.

13. The method of terminating a steel tube in an umbilical without the use of a welded retention sleeve of claim 9, wherein the glue comprises single-part epoxy or a two-part epoxy.

14. The method of terminating a steel tube in an umbilical without the use of a welded retention sleeve of claim 9, further comprising designing the retention sleeve such that its load bearing surface comprises an area configured such that when the yield of the steel tube is reached the stress on a surrounding potting resin is below the resin's compressive limit.

15. The method of terminating a steel tube in an umbilical without the use of a welded retention sleeve of claim 9, wherein:
a. the steel tube comprises a load bearing steel tube; and
b. the length of the retention sleeve is configured to comprise an area sufficient to disperse a lap shear stress on the glue imparted from the load bearing steel tube such that the lap shear strength is not exceeded.

16. The method of terminating a steel tube in an umbilical without the use of a welded retention sleeve of claim 15, wherein the load bearing steel tube comprises a tensioned load bearing steel tube.

17. The method of terminating a steel tube in an umbilical without the use of a welded retention sleeve of claim 9, wherein the steel tube comprises a plurality of steel tubes.

18. The method of terminating a steel tube in an umbilical without the use of a welded retention sleeve of claim 9, wherein the steel tube comprises a plurality of load bearing steel tubes.

19. A terminated steel tube in an umbilical termination made by the process of claim 1.

20. A terminated steel tube in an umbilical termination made by the process of claim 9.
